(19) United States
(12) Patent Application Publication
(10) Pub. No.: US 2002/0138381 A1
(43) Pub. Date: Sep. 26, 2002

(54) Individually managed accounts with multiple style allocation options

(76) Inventor: Christopher Tomecek, Hingham, MA (US)

Correspondence Address: DUANE MORRIS, LLP, ATTN: WILLIAM H. MURRAY, ONE LIBERTY PLACE, 1650 MARKET STREET, PHILADELPHIA, PA, 19103-7396, US

(21) Appl. No.: 09/760,932

(22) Filed: Jan. 16, 2001

(51) Int. Cl. G06F 17/60

(52) U.S. Cl. 705/36

(57) ABSTRACT

In a method for managing investments, a style allocation is selected for an investor through at least one of a series of individually managed accounts. A capability is provided for the style allocation to include a stylized portfolio. A capability is provided for the style allocation to include a model portfolio. This includes determining a growth strategy that provides an acceptable expected return with an acceptable risk for the investor, based on information about the investor. A capability is provided for the style allocation to include an industry sector portfolio. This type of portfolio allows an investor to specify one or more specific industries in which to invest his or her assets. Any combination of one or more of the style allocations described above may be selected. An individually managed account (IMA) is provided for the investor, the IMA using the selected style allocation.

### FIELD OF THE INVENTION

The present invention relates to investment products and methods generally, and more specifically to individually managed accounts.

### BACKGROUND OF THE INVENTION

Individually managed accounts and mutual funds are two of the most popular investment vehicles used by individual investors.

A mutual fund is a '40 Act registered company that invests in equities, bonds or other securities on behalf of investors. A plurality of investors buy shares of the company. The fund uses the assets in the company to make investments and pay for management and administrative expenses of the fund. The investors cannot control the buying or selling of individual securities by the fund. The investors can only buy or sell shares of the fund. The investors pay a pro rata share of realized capital gains experienced by the fund, regardless of whether the investor actually benefited from the securities' gains. For example, if the fund buys a stock that doubles in value during the year before the investor buys shares of the fund, and the stock decreases in value by 10 percent after the investor buys shares of the fund, the investor is taxed on a capital gain for a pro rata share of that stock, even though the investor's pro rata share of that stock actually decreased in value.

In recent years, the individually managed account (IMA) has increased in popularity as an alternative to ownership of mutual funds. An individually managed account is a separate, individualized portfolio of investments that is owned directly by an investor and managed by a professional investment manager. The investor typically works with a financial advisor to develop an investment strategy, taking into account the investor's growth objectives, risk tolerance, investment timeline horizon and tax situation. Because the investor directly owns the securities, the investor does not incur tax liability for growth in the securities' values that occurs prior to the purchase of the securities by the individual investor. The investor only pays taxes on capital gains that are realized on their behalf. Sell decisions can be planned to minimize the individual investor's tax liability.

IMA's have many other advantages. The assets in an IMA portfolio are only purchased or sold to benefit the investor who owns that account. In contrast, a mutual fund may sell assets at depressed prices to raise cash to pay off investors, if the investors redeem shares of the fund, regardless of whether the sales make sense from an investment standpoint.

Another advantage of an IMA is that 100% of the assets are invested. In a mutual fund, a greater percentage of cash (relative to an IMA) is normally held in reserve, to enable the fund to meet redemption requests.

Conventional IMAs provide a stylized portfolio. Working with the financial advisor, the stylized portfolio is selected from a group which may, for example, include: large-capitalization core stocks, large capitalization growth stocks, mid-capitalization stocks, small-capitalization growth stocks, small-capitalization core stocks, international stocks, taxable fixed income investments and tax-exempt fixed income investments.

Historically, because of the higher level of service and individual attention by the account manager, the minimum investment for an IMA has been much higher than that of most mutual funds. A typical minimum investment for an individually managed account is $100,000 per style, whereas mutual funds may often be purchased with a minimum investment of $1000 or less.

An investment product with greater flexibility is desired.

### SUMMARY OF THE INVENTION

The present invention is a methodology for managing investments. A style allocation is selected for an investor through at least one of a series of individually managed accounts. A capability is provided for the style allocation to include multiple stylized portfolios. A capability is provided for the style allocation to include a model portfolio. A capability is provided for the style allocation to include industry sector portfolios. Individually managed accounts (IMA) are provided for the investor, the IMA using the selected style allocation.

### BRIEF DESCRIPTION OF THE DRAWINGS

FIG. 1 is a flow chart of an exemplary process according the present invention.

FIG. 2 is a detailed flow chart of an exemplary process for generating papers associated with creation of an individually managed account, as shown in FIG. 1.

FIG. 3 is a detailed diagram of a computer implemented embodiment of the method of FIG. 1.

FIG. 4 is a block diagram of the participants in an exemplary method according to the invention.

### DETAILED DESCRIPTION

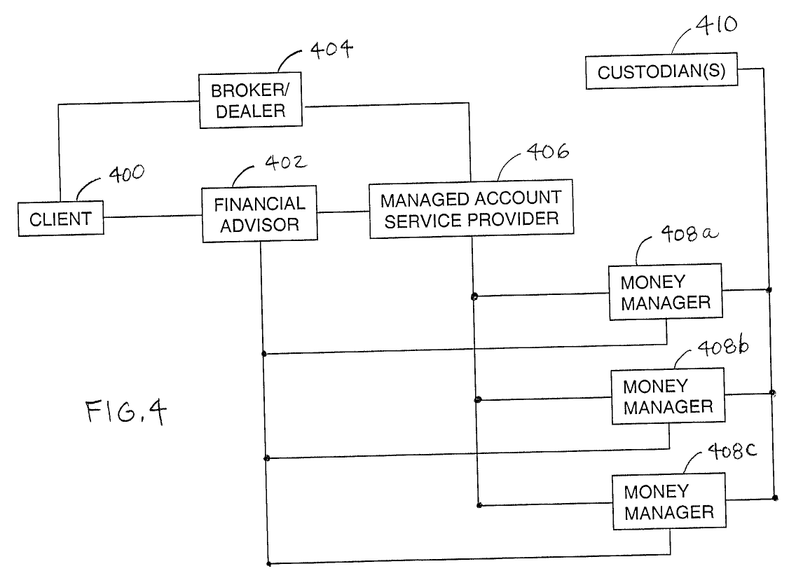

FIG. 4 is a block diagram showing an exemplary set of parties involved in the exemplary method. The client 400 is the ultimate investor. The client 400 may be an individual, an institutional investor, a trust, or other entity.

The client 400 interfaces with a financial advisor, which may be either an independent financial advisor 402 or a financial advisor working with a broker/dealer 404. Reference is hereafter made to financial advisor 402, but it will be understood that an advisor employed by a broker/dealer 404 could also perform similar functions. The financial advisor 402 works with the client 400 to determine an asset allocation (among stocks, bonds, cash real estate and other broad investment categories) tailored to market conditions, the client's financial needs, and the client's stage in life. The financial advisor 402 assists the client 400 in identifying investment objectives and matching those objectives to a money manager 408a-408c who is suited to managing the client's portfolio in accordance with the client's time horizon, risk tolerance, investment objectives, and tax planning strategies. The financial advisor 402 interfaces with the managed account service provider 406 to set up the investment accounts on behalf of the client 400. Once the accounts are established, the financial advisor 402 receives reports from the money manager 406 financial advisor 402 who assists the client 400 in understanding the reports.

The managed account service provider 406 provides a variety of services to facilitate the establishment of the individually managed account. The managed account service provider may provide an online network-based tool to assist the financial advisor 402 in developing an asset allocation for the client 400, and for receiving the advisor's input selection of asset allocation and then the style allocation for the client's assets. Based on the selected style allocation, the managed account service provider 406 identifies one or more money managers 408a-408c, who are well suited for managing the client's portfolio. The money managers 408a-408c are selected from a pool of money managers whom the managed account service provider 406 has pre-screened, and with whom the managed account service provider negotiated participation in the program. Upon selection of the money manager 408a-408c by the financial advisor 402, the managed account service provider 406 generates a proposal with all the necessary paperwork for establishing the account(s).

The money manager(s) 408a-408c manages the account by purchasing and selling securities on behalf of the investor 400 based on the investor's selected style allocation, investment time horizon, tax situation, and market conditions. The money manager issues reports (for example, monthly or quarterly), which the financial advisor 402 reviews with the investor 400.

The custodian 410 performs the conventional function of brokerage trading, settlement and clearing in response to the purchase and sale orders of the money manager, who does not actually take possession of the stock certificates. This function is understood by those skilled in the art and is not described in detail herein.

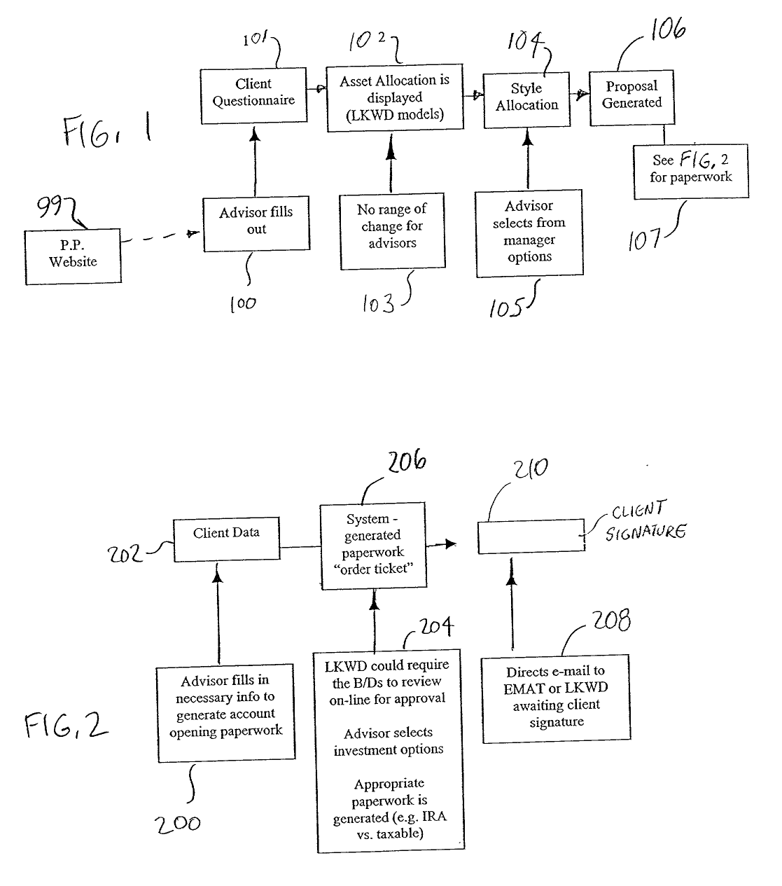

FIG. 1 is a flow chart of an exemplary method according to the present invention. The invention is an investment product and a method for providing the product. The product is a process and methodology for the selection and creation of individually managed accounts, which allows the option of selecting one or more style allocations from a plurality of style allocations. The exemplary individually managed account may include one or more style allocation components, with independent options for including a stylized portfolio, a model portfolio, and/or an industry sector portfolio in the style allocation.

At blocks 99-101, the financial advisor optionally uses an online tool, which may be Internet-based, to enter client specific information. The tool may optionally be provided by the managed account service provider 406. At step 99, the financial advisor 402 accesses the system, for example, by accessing the Worldwide Web site of the managed account service provider 406, which is preferably protected by password or other authentication mechanism.

At step 100, the financial advisor 402 fills out a questionnaire 101 regarding the client 400. The questionnaire 101 may include such parameters as age, income, assets to be invested, investment horizon, growth objectives, risk tolerance, required distributions, and the like.

The exemplary embodiment provides a fixed risk propensity scale, for example, 1 to 10, with a risk of 5 being the level of risk associated with ownership of an S&P 500 portfolio. Optionally, at step 103, the online tool may provide a capability for the financial advisor to reconstruct the range of risk propensity while filling out the questionnaire, to provide greater precision in the assessment. The financial adviser will change the risk scale, and thereby, alter the style allocation percentage to riskier styles.

At step 102, the online tool displays a recommended asset allocation for the client 400. The asset allocation identifies how the portfolio should be allocated among stocks and fixed income investments (e.g., bonds).

At step 104, the financial advisor 406 creates the style allocation for the client. Unlike available investment products in the prior art, the exemplary managed account service provider 406 provides three different options for individually managed accounts implementation.

The capability is provided for the style allocation to include a stylized portfolio. Stylized portfolios are well known, and may include: large-capitalization core stocks, large-capitalization growth stocks, mid-capitalization stocks, small-capitalization growth stocks, small-capitalization core stocks, international stocks, taxable fixed income securities, and tax-exempt fixed income securities, and the like.

The capability is provided for the style allocation to include a model portfolio. This group of portfolio options includes individually managed accounts geared toward “lifestyle” choices. This includes determining a growth strategy that provides an acceptable expected return with an acceptable risk for the investor, based on information about the investor. The options may include, for example: balanced portfolios, moderate growth portfolios, growth portfolios, and aggressive growth portfolios. In choosing between model portfolios, the financial advisor 402 is likely to pay particular attention to the age and investment horizon of the client 400, as well as the advisor's personal knowledge of the client's propensity towards risk-taking and the total amount of the client's investable assets.

The capability is provided for the style allocation to include an industry sector portfolio. This type of portfolio allows an investor to specify one or more specific industries in which to invest his or her assets. For example, the industry sector options may include: technology, telecommunications, financial products, consumer products, energy, and industrials. Other sectors may be made available, as warranted by market conditions and/or client requests.

According to another aspect of the invention, the financial advisor 402 can specify any combination of one or more of the style allocations described above. For example, the financial advisor can specify that half of the investor's assets are invested in an aggressive growth (model) portfolio, and half are invested in an energy (industry sector) portfolio. Further, more than one portfolio within a single style option may be selected. For example, one third of the assets may be in a large cap core stock portfolio, one third in a tax-exempt fixed income portfolio, and one third in the financial sector products.

At step 105, the managed account service provider 406 provides the financial advisor 402 with a list of one or more money mangers 408a-408c specifically suited to manage the portfolio of this specific client 400. At least two money manager choices are identified for each style allocation option.

At step 106, once the style allocation and the money manager(s) are selected, a proposal for the individually managed accounts is generated. The proposal is automatically generated by the software tool provided by the managed account service provider 406, and is either downloadable or printable in the computer of the financial advisor 402. The proposal includes all papers that are required to be submitted to the client 400 for signature in order to establish the individually managed account portfolio. The financial advisor 402 can accept this proposal and submit it to the client 400 for signature. The proposal includes a summary of client objectives and risk of selected managers, a profile of each manager selected and various historical data. Unlike the prior art methods, this product is available for mass distribution and the first with three different options.

Alternatively, at step 107, the financial advisor 402 has the option to substitute his or her own proposal for the automatically generated proposal provided by the managed account service provider 406, as explained below.

When the client 400 has approved and signed the papers, the papers and cash needed to open the account are turned over to the managed account service provider 406, which opens the necessary brokerage account(s) and interfaces with the money managers 408a-408c. The money manager(s) 408a-408c are notified when the account is opened, and the manager(s) begin trading the account(s) on behalf of the client 400. The brokerage trading and settlement and clearing is performed by the custodians 410.

In most instances, the objectives and style allocations of a client cannot be met by a single money manager, and it is preferred to establish multiple portfolios managed by different money managers 408a-408c. Due to Securities and Exchange Commission (SEC) requirements, assets cannot be commingled among two or more money managers 408a-408c in a single account. To meet the client's objectives, the managed account service provider 406 may establish two (or more) separate brokerage accounts, one per money manager. Preferably, to streamline the administration of the client's assets, the brokerage accounts are established as a series of individually managed accounts.

The managed account service provider is responsible for clearing, trading, back office functions, account billing and general brokerage operations. The manager is the contractor with authority to make investment decisions. Trades executed through interaction between the manager and the managed account service provider.

Once the series of accounts are set up, the client can revise his strategies along with the financial advisor, who passes this information on to the money manager. For example, the investor can request transfer of cash from one account to another. The letter of agreement may provide, for example, quarterly or annual tax planning adjustments are communicated to the money manager.

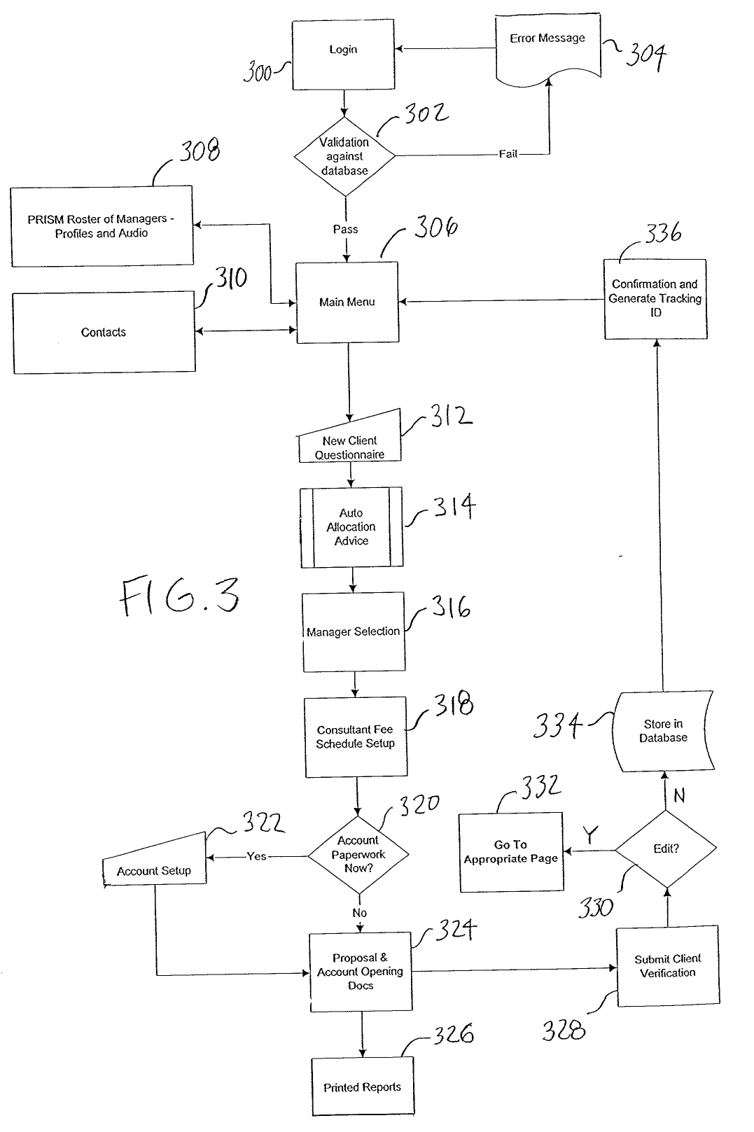

FIG. 2 shows the option for using a proposal generated by the financial advisor 402. Using the procedure of FIG. 2, the financial advisor can establish an individually managed account without using the automated proposal component of the online tool described above.

At step 200, the financial advisor 402 fills in the necessary information to generate the necessary paperwork with client data 202 for opening the managed account(s).

At step 204, the financial advisor 402 selects investment options for the individually managed account. For example, the financial advisor may use a prior art technique for determining an asset allocation (mix of stocks, fixed income securities and cash). Further, the advisor may use any desired method for determining a style mix and input the desired style mix (a “pick-it”) to request a series of individually managed accounts in accordance with the requested style mix. Preferably, for each style option selected, the system allows the user to view the performance history of each money manager 408a-408d available for that style option.

At step 206, the system generates order instructions for the new IMA.

At step 208, the financial advisor 402 transmits the proposal to the managed account service provider 406, optionally using electronic mail, optionally using an online tool such as the electronically managed account technology.

At step 210, the papers are ready for signature by the client 400.

FIG. 3 is a flow chart showing a fully automated electronic system for establishing an individually managed account according to the invention.

At step 300, the user (financial advisor 402) logs into the system. At step 302, the user's password is authenticated, and the user may be asked to accept the terms of a software license agreement. At step 304, an error message is provided if the password is incorrect or the user does not agree to the license terms.

At step 306, the user is presented the main menu options. In the exemplary embodiment, these options include establishing a new client, reviewing or revising the information for an existing client, and various options for the managed account service provider's programs.

At step 308, the user has the option of proceeding directly to a list of the available money managers, along with a profile for each manager.

At step 310, the user has the option of viewing a contact list for employees of the managed account service provider 406.

At step 312, if the user selects the new client option, the user is presented a series of input screens for entering the required data. Questions cover basic investor profile inputs, and risk selection.

At step 314, based on the risk level selection, an auto-allocate function determines a recommended style mix and a set of recommended managers.

At step 316, the user can accept the suggested managers or change either or both of the style mix and the selection of managers. The user can change the absolute dollar amounts allocated to each of the series of accounts. Preferably, the system automatically applies rules to keep the style mix within accepted limits. For example, the system may be programmed to limit the maximum portion of the client's assets to be invested in any single industry sector to 25%. If the user requests a style mix that exceeds any of the pre-programmed suitability limits, the system provides a “red flag” and does not let the user continue to the next screen until the requested style mix is changed to be within the predetermined limits.

Preferably, for each of the series of individually managed accounts to be established, the user is provided with at least two different choices of money managers from which to choose.

At step 318, a fee schedule may optionally be input for the financial advisor 402.

At step 320, the user determines whether to generate a set of account paperwork. If the user requests the paperwork, then at step 322, the user inputs data for all required fields and account titles for the paperwork before proceeding to step 324.

At step 324, the proposal and account opening documents are generated, if the user has completed the account setup properly. At step 326, the report is printed.

At step 328, the proposal is submitted to the client 400 for verification and approval.

At step 330, if the client 400 edits the report, then the user returns to the appropriate page and enters the changes.

At step 334, the verified client data are entered in the database. At step 336, a confirmation is issued and a tracking ID is generated. The system then returns to the main menu (step 306) for further operations.

In the exemplary system, the wrap fees are allocated among the parties. For example, the following schedule may be followed: Unlike prior products, this product is the first to pay out a distribution fee in the non-wirehouse environment and the first in the independent (402) channel. Distribution fees were previously used only with mutual funds.

TABLE 1

| | | | | Managed | |
|---|---|---|---|---|---|
| | | Brokerage | | Account | Total |
| | Money | Clearing/ | Distribution/ | Service | (basis |
| Asset Level | Manager | Custody * | Pay-out | Provider | points) |
| First 500,000 | 40 | 5 | 20 | 45 | 110 bp |
| $500,000 to | 40 | 5 | 18 | 42 | 105 bp |
| $1.5 Million | | | | | |
| $1.5 Million | 40 | 5 | 15 | 40 | 110 bp |
| to $3 Million | | | | | |
| >$3 Million | 40 | 5 | 13 | 37 | 95 bp |

* Optionally, a ticket charge (for example, $5.00) may be added.

An alternative fee structure may be offered with unbundled (no wrap) pricing. This option will primarily be offered to stand alone registered investment advisors (no broker/dealer affiliation), and to larger investors. This alternative fee structure is used where the client seeks the use of only certain parts of the process. An exemplary structure for unbundled pricing follows:

TABLE 2

| | |
|---|---|
| Money Manager | .45 |
| Brokerage/Clearing/Custody | .05 |
| Managed Account Service Provider | .50 |
| Total | 1.00 |

In addition to fee structures, the managed account service provider 406 may impose minimum account size. For example, the minimum account may be set as low as $50,000, which is substantially lower than the $100,000 minimums set for IMAs in the prior art.

The present invention may be embodied in the form of computer-implemented processes and apparatus for practicing those processes. The present invention may also be embodied in the form of computer program code embodied in tangible media, such as floppy diskettes, read only memories (ROMs), CD-ROMs, hard drives, ZIP™ drives, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a processor, the processor becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claim should be construed broadly, to include other variants and embodiments of the invention, which may be made by those skilled in the art without departing from the scope and range of equivalents of the invention.

What is claimed is:

1. A method for managing investments, comprising the steps of:
(a) selecting a style allocation for an investor through at least one of a series of individually managed accounts, including the steps of:
(i) providing the capability for the style allocation to include a stylized portfolio;
(ii) providing the capability for the style allocation to include a model portfolio; and
(iii) providing the capability for the style allocation to include an industry sector portfolio; and
(b) providing an individually managed account (IMA) for the investor, the IMA using the selected style allocation.

2. The method of claim 1, wherein:
step (ii) includes determining a growth strategy that provides an acceptable expected return with an acceptable risk for the investor, based on information about the investor; and
step (b) includes providing an IMA that conforms to the determined growth strategy.

3. The method of claim 1, wherein step (iii) includes specifying a plurality of predetermined industries that are selectable by the investor, at least a portion of any assets in the IMA being invested in the selected industry.

4. The method of claim 1, wherein step (a) includes a capability to select a style allocation that includes at least two of the group consisting of a stylized portfolio, a model portfolio, and an industry sector portfolio.

5. The method of claim 1, further comprising the steps of:
(a) identifying a plurality of account managers capable of managing the IMA, based on the style allocation; and
(b) providing the capability to select at least one of the identified account managers.

6. The method of claim 1, further comprising:
electronically receiving input data identifying characteristics of the investor; and
automatically generating a proposed asset allocation and a proposed style allocation that are suitable for use in step (a).

7. A system for managing investments, comprising:
means for selecting a style allocation for an investor through at least one of a series of individually managed accounts, including:
first means for inputting a style allocation that includes a stylized portfolio;
second means for inputting a style allocation that includes a model portfolio; and
third means for inputting a style allocation that includes an industry sector portfolio; and
means for generating a proposal for an individually managed account (IMA) for the investor, the IMA using the selected style allocation.

8. The system of claim 7, wherein:
the second means include means for determining a growth strategy that provides an acceptable expected return with an acceptable risk for the investor, based on information about the investor; and
the proposal generating means include means for generating a proposal to provide an IMA that conforms to the determined growth strategy.

9. The system of claim 7, wherein the third means include means for specifying a plurality of predetermined industries that are selectable by the investor, at least a portion of any assets in the IMA being invested in the selected industry.

10. The system of claim 7, wherein the style allocation selecting means include means for selecting a style allocation that includes at least two of the group consisting of a stylized portfolio, a model portfolio, and an industry sector portfolio.

11. The system of claim 7, further comprising:
means for identifying a plurality of account managers capable of managing the IMA, based on the style allocation; and
means for selecting at least one of the identified account managers.
